(19) United States
(12) Patent Application Publication
(10) Pub. No.: US 2015/0369264 A1
(43) Pub. Date: Dec. 24, 2015

(54) SENSING METHOD FOR FIBER-DRIVEN MOTION SYSTEMS

(71) Applicant: THE REGENTS OF THE UNIVERSITY OF MICHIGAN, Ann Arbor, MI (US)

(72) Inventors: WYATT M. FELT, Ann Arbor, MI (US); C. David Remy, Ann Arbor, MI (US)

(21) Appl. No.: 14/743,062

(22) Filed: Jun. 18, 2015

Related U.S. Application Data
(60) Provisional application No. 62/014,772, filed on Jun. 20, 2014.

(51) Int. Cl. F15B 15/10

(52) U.S. Cl. CPC F15B 15/103

(57) ABSTRACT

A self-sensing fiber-driven motion system having an actuator moveable between a first configuration and a second configuration, fibers generally surrounding the actuator that change from a first orientation to a second orientation in response to force exerted upon the fibers caused by the movement of the actuator from the first configuration to the second configuration, electrically conductive elements generally following the fibers such that an electrical condition of the electrically conductive elements changes from a first electrical condition to a second electrical condition in response to the changing of the fibers from the first orientation to the second orientation, and a sensor system detecting a change of electrical condition from the first electrical condition to the second electrical condition, thereby determining a movement of the actuator in response to the change of electrical condition.

### CROSS-REFERENCE TO RELATED APPLICATIONS

This application claims the benefit of U.S. Provisional Application No. 62/014,772, filed on Jun. 20, 2014. The entire disclosure of the above application is incorporated herein by reference.

### FIELD

The present disclosure relates to an apparatus and method to measure the motion and force output of fiber-driven motion systems.

### BACKGROUND AND SUMMARY

This section provides background information related to the present disclosure which is not necessarily prior art. This section also provides a general summary of the disclosure, and is not a comprehensive disclosure of its full scope or all of its features.

Fiber-driven motion systems are well known and useful in a wide variety of applications. These motion systems often employ a fiber-constrained drive system that result in different spatial paths for the fibers and different stress in the fibers when subjected to external (e.g. tensions and/or torques) or internal forces (e.g. pressures from a fluid-filled bladder or heat-induced strain).

In some systems, fiber-driven motion systems include devices that are driven by coiled fibers. One type of motion system driven by coiled fibers is often called a “Twisted String” actuator (see U.S. Patent Pub. No. 2008/0066574 A1). These actuators correlate a change in the twist of fibers or bundles of fibers with a change of length of the system. Often these systems are used to generate or respond to an external torque. Additionally, coiled fiber motion systems can be driven by the strain of the fibers (see WO 2014022667 A3). Such systems are designed to magnify small changes in the fiber shape into larger motions (or vice-versa). Furthermore, coiled fibers can employ a knit structure. For example, some knit structures can change their shape in response to external forces. Some knit structures can create external forces by using “active” fibers that seek to change their shape when exposed to heat.

Fiber-driven motion system may also employ soft-fluidic actuators. These devices are particularly useful in factory automation and robotics, because they generate high forces, withstand impacts, do not need to be precisely aligned, and can be used in harsh and dirty environments. These actuators use the tensile strength of fibers wrapped around an elastomeric bladder to shape the expansion of a fluid under pressure within the bladder. This class of actuators includes devices that bend, twist, curl and extend under pressure (see U.S. Patent Pub. No. 2015/0040753 A1). This class also includes devices that contract or extend along their length similar to biological muscles. An example of a soft-fluidic actuator that extends is a bellows (e.g. a convoluted tube). An example of a soft-fluidic actuator that contracts is a “straight-fiber” artificial muscle (see WO 2008140032 A1). Straight-fiber artificial muscles can be made with an internal bladder that is cylindrical or flat and may be pleated or not. McKibben muscles are soft fluidic actuators that extend or contract. Other fiber-driven soft fluidic actuators can be formed by surrounding an elastomeric bladder with a reinforcing woven-fiber structure like fabric.

In automation and robotics, any “actuator” that makes the system move (e.g. an electric motor or an air muscle) is likely to be paired with a sensor that tracks the movement, so the motion can be controlled. Usually, a “position encoder” is used to measure such movement. Many electric motors are sold with embedded encoders and known as “servomotors”. These “servomotors” represent a step forward in the value chain by providing the needed functionality of the encoder in a single device. Yet, depending on the application, other sensors are possible, most notably a force-transducer that allows one to measure and control the force created by an actuator.

Many fiber-driven motion systems have yet to be integrated with such sensors. This means that currently they need to be used with an external encoder and/or force transducer. Unfortunately, typical external encoders and force transducers have exactly the opposite properties of the motion systems they are paired with: they can be damaged by the shock of impacts, they need well defined axes of motion, they must be precisely aligned, and they cannot readily be used in harsh and dirty environments. Moreover, traditional encoders and force transducers add weight and complexity to robotic systems. The requirements of these sensors have broad, negative impacts on the entire robot design; part of the reason robots are so costly is that they must often be made of metal machined to very tight tolerances. Robots that use Air Muscles that could sense their own position and force would not necessarily need such expensive, heavy structures.

According to the principles of the present teachings, an apparatus and method to measure the motion and force output of fiber-driven motion systems is provided. In some embodiments, the present technology provides that some or all of the fibers in a fiber-driven motion system be made from electrical conductors that form part of an electrical circuit. Changes in the inductance and/or resistance of this circuit can be related to the motion of the fiber-driven system and the force that it is generating or subject to. In some embodiments, the approach includes McKibben muscles evaluated under a variety of air pressures and external loads. According to the principles of the present teachings, force and length can be determined, by way of non-limiting example, with an accuracy of approximately 5 N and 1 mm, respectively. This technique can be used to create flexible, precise, and robust self-sensing actuators that benefit a multitude of robotic applications.

In some embodiments, the present teachings creates a force-controllable “servomotor” out of an fiber-driven motion system by employing the change in fiber orientation and stress in the fibers to create a virtual encoder embedded in the structure of the system. The present teachings do not add sensors to the system, but rather construct it to include conductive fibers (instead exclusively insulating fibers as is typical). The change in the inductance and/or resistance can provide a measure of the motion of the system and how much force it is producing or subject to. By connecting the fibers in series or by using a continuous fiber to form the entire structure, the effects of the changes in inductance and/or resistance are magnified. This allows the fiber-driven motion system to work with compliant joints and human joints, and in harsh and dirty environments unsuitable for traditional encoders and force transducers. In some embodiments, the encoder can work by sensing the change in inductance and/or resistance as fiber-driven soft actuator moves, generates, or is subjected to external forces. The change in these values comes from the change in geometry of the fiber sheath (i.e. the alignment and/or distance between the wires changes with the actuator motion and the actuation force causes a strain in the wires).

In some embodiments, this self-sensing fluidic actuator uses the changing electrical properties in its reinforcing fiber structure to measure contraction and force output. To this end, the sheath of the pneumatic actuator is made from insulated conductive fibers that form a single electric circuit. The inductance and/or resistance of this circuit changes in reaction to the force on the actuator and its degree of contraction. External forces introduce a strain on the wires, thereby changing the resistance of the circuit. The change in length causes the current in the wires to become more aligned and results in an increase in inductance. This allows the actuator to be used without external encoders.

In some embodiments, the structure of the actuator includes a flexible, inner tube and a fiber sheath. The sheath is made of fibers that shape the expansion of the bladder. When pressurized, the actuator contracts axially, expands axially, twists about its axis, bends, or coils as it grows in volume. Because the fibers of the sheath are practically inextensible, the volume increase is accomplished through a change in shape of the sheath. During this expansion, there is a change in either the distance between the fibers of the sheath or in their angle with respect to the actuator.

To make the sheath into a circuit whose inductance is sensitive to the sheath shape, some or all of the fibers in the sheath are made to be electrically conductive. These conductive fibers, referred to as wires, may be connected in series or wound with a continuous length to magnify the effect of the change in inductance. They may be insulated from each other to prevent current from flowing between the wires along their length. In the case of a McKibben Muscle configuration, the fiber sheath may be made of right-handed and left-handed helices. The wires of the sheath may be connected or wound so that the current moves from a right-handed helix to a left-handed helix to a right-handed helix (and so forth). In this configuration, when connected to a voltage source, current travels up the actuator along one helix and down another helix of the opposite hand, creating a net current that flows around the actuator axis in a single direction (FIG. 1A). The change in resistance comes from a mechanism very similar to that of a strain gauge.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A illustrates a self-sensing fiber-driven motion system according to the principles of the present teachings having helical fibers of equal pitch and different handedness surrounding an inner bladder in a deflated position;

FIG. 1B illustrates a self-sensing fiber-driven motion system according to the principles of the present teachings having helical fibers of equal pitch and different handedness surrounding the inner bladder of FIG. 1A in an inflated position;

FIG. 2A illustrates a self-sensing fiber-driven motion system according to the principles of the present teachings having parallel fibers running generally along an axis of and surrounding an inner bladder in a deflated position;

FIG. 2B illustrates a self-sensing fiber-driven motion system according to the principles of the present teachings having parallel fibers running generally along an axis of and surrounding the inner bladder of FIG. 2A in an inflated position;

FIG. 3A illustrates a self-sensing fiber-driven motion system according to the principles of the present teachings having parallel fibers running generally along an axis of and surrounding a rectangular-shaped inner bladder in a deflated position;

FIG. 3B illustrates a self-sensing fiber-driven motion system according to the principles of the present teachings having parallel fibers running generally along an axis of and surrounding the rectangular-shaped inner bladder of FIG. 3A in an inflated position;

FIG. 4 illustrates a self-sensing fiber-driven motion system according to the principles of the present teachings with a twisted coil of fibers;

FIG. 5 is a schematic view of a bundle of conductive fibers according to the present teachings;

FIG. 6A illustrates a self-sensing fiber-driven motion system according to the principles of the present teachings having a generally constant surface area configuration;

FIG. 6B illustrates a self-sensing fiber-driven motion system according to the principles of the present teachings having a foldable configuration;

FIG. 7A illustrates a self-sensing fiber-driven motion system according to the principles of the present teachings having helices of the same hand configuration;

FIG. 7B illustrates a self-sensing fiber-driven motion system according to the principles of the present teachings having a varying magnetic field during movement; and

FIG. 7C illustrates a self-sensing fiber-driven motion system according to the principles of the present teachings having helices of opposite hands.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Introduction

With reference to the figures, a self-sensing fiber-driven motion system 10 is illustrated in accordance with some embodiments of the present teachings having a sensing system 12 for detection of a state of contraction or extension of a soft fluidic actuator 13.

It should be appreciated that the principles of the present teaching, such as using conductive fibers 20 to provide both sensing system 12 and tension-bearing structure, can be applied to other types of fiber-driven motion-systems. Moreover, the modeling techniques discussed herein can be used to create self-sensing fiber-driven motion systems.

In some embodiments, self-sensing fiber-driven motion system 10, which is particularly useful in robotic applications, can comprise soft fluidic actuator 13, made with flexible bladder 14 (such as a flexible inner tube, elastomeric bladder, or the like), that is selectively fillable and/or inflatable with pressurized air or other fluid from a source. A fiber sheath 16 can be disposed about a flexible bladder 14 and sized to closely conform to an exterior surface of flexible bladder 14. Generally, fiber-driven soft fluidic actuators 13 can use the tensile strength of fiber sheath 16 wrapped about soft fluidic actuator 13 to shape the expansion of flexible bladder 14 filled with fluid under pressure. This class of actuators includes devices that bend, twist, curl, and extend under pressure, and may also include devices that contract along their length (i.e. longitudinally) like biological muscles. In some embodiments, soft fluidic actuator 13 is a Pneumatic Artificial Muscle (PAM) or McKibben Muscle.

PAMs, like other fiber-driven motion systems 10, are compliant and force-dense. A PAM can be made from flexible and lightweight materials. They can create ten times the pulling force of a traditional pneumatic cylinder of the same diameter without the friction from sliding seals. The compliant and sealed structure of PAMs enables them to be used without the precise alignment or protection from the elements that servomotors require.

The properties of PAMs have led to a variety of applications. Their force density makes them useful in bio-mimetic robots that jump and run. Their compliance makes them attractive for use in robots with soft joints or in continuum robots that lack discrete joints. The ability of PAMs to function without rigid linkages or precise alignments has led to widespread application in powered orthoses and exoskeleton devices.

In robotic applications, it is often necessary to pair fiber-driven motion system 10 with a sensing system 12 to allow for closed-loop control of the generated motions. Traditional sensing systems, however, have limited usefulness in many PAM-actuated robots. In particular, traditional sensing systems must be kept clean and dry for proper operation and should be coupled to rigid mechanical joints for accurate sensing. These conditions are not always available in robots that rely on PAM actuators. For instance, some PAM-actuated running and walking robots may operate in muddy and/or wet environments. Although the PAMs themselves have no need to remain clean and dry, attempts to protect the encoded joints from the elements can add weight, complexity, and cost.

Similarly, traditional sensing systems are designed to be connected to single-degree-of-freedom, rigid mechanical joints. Many robots do not offer such conventional coupling points. Trunk-like manipulators, for example, often rely on strings running along their length to track the curvature of the sections. The volumetric bulk of string-recoil systems and the vulnerability of the strings to friction and breakage limit the usefulness of this technique. Devices that rely on the movement of human joints are also difficult to track with traditional sensing systems, thus tracking of human joints is often achieved by attaching rigid sections with a traditional joint and sensing system (e.g. a goniometer at the elbow or knee). These mechanical linkages may needlessly restrict the user's motion simply to provide a coupling point. Thus, the performance of robotic systems that rely on PAMs is often restricted by traditional sensing systems.

According to the principles of the present teachings, self-sensing fiber-driven motion system 10 (which, in the case of a PAM may be sensing contraction or extension) is provided that overcomes the limitations of conventional systems and provides a cost effective, efficient, and reliable system. Systems according to the present teachings can provide position feedback with compliant joints, in continuum robots, or while interfacing with the human body. To this end, several embodiments have been developed and will be discussed in detail herein.

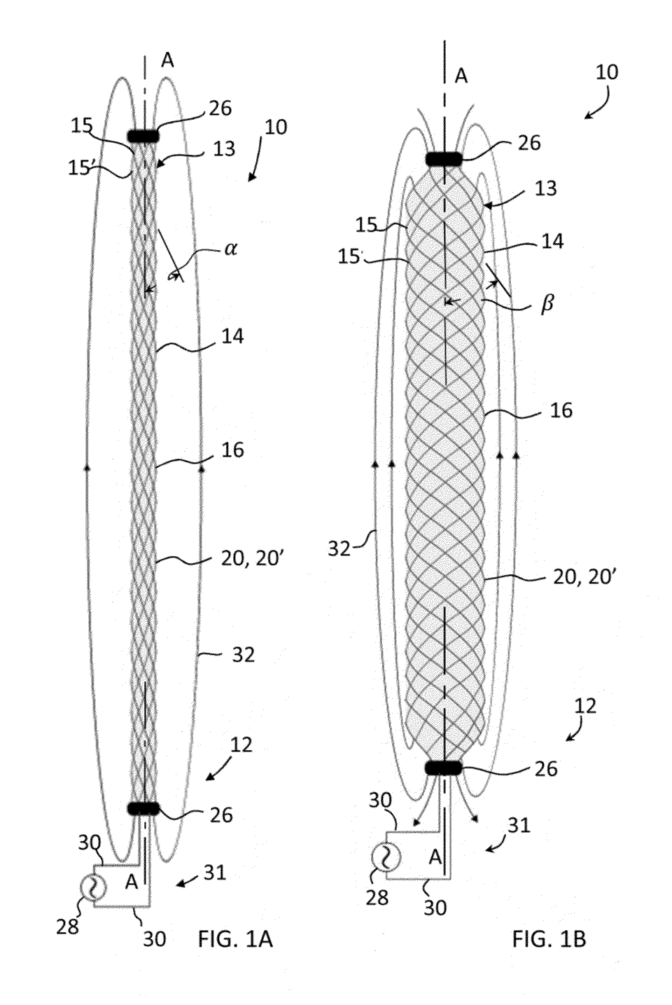

Some attempts have been previously made to detect the state of contraction or extension of soft fluidic actuators, such as through the measuring of strain in the flexible bladder, using dielectric elastomers to sense PAM contraction, using a low melting point alloy embedded in the flexible bladder to sense the contraction, or simply measuring the distance between end couplers using a transducer. However, according to the principles of the present teachings, the reinforcing fibers of fiber sheath 16, disposed about flexible bladder 14, are used as the sensing element. As will be discussed in greater detail herein, such sensing system can be achieved using conductive fibers 20 within fiber sheath 16. In some embodiments, conductive fibers 20 can include insulated wires that are connected in series. Conductive fibers form an electrical circuit 31 such that current passes about longitudinal axis A-A of soft fluidic actuator 13 as if it was a solenoid (FIG. 1A). When, in the case of a PAM, soft fluidic actuator 13 contracts axially and thus expands radially (FIG. 1B), the current in conductive fibers 20 becomes more aligned and the inductance of circuit 31 increases, thereby resulting in measurable and quantifiable change. This change in inductance, for example, can be used to determine an associated state of contraction or extension.

Conductive Fibers

While a fiber sheath of conventional PAMs is typically made with polymer fibers, fiber sheath 16 of the present teachings employs conductive fibers 20. Conductive fibers 20 may be electrically insulated so that current is constrained to flow along the fiber length. One way to manufacture the conductive set is to layer the right-handed helices 15 and left-handed helices 15′ of fiber sheath 16 instead of braiding them or interweaving them. This technique has been used with soft fluidic actuators 13 and does not substantially change their function. The helices of fiber sheath 16 can be layered over a non-conductive element 22, such as a flexible template, or fiber sheath 16 may be covered with a non-conductive element 22, such as flexible structure, to help fiber sheath 16 maintain its form. Non-conductive element 22 may be made from or include conductive material, but is non-conductive in the sense that it is electrically insulated from conductive fibers 20 (possibly the insulation on conductive fibers). Non-conductive element 22 may contain magnetic materials, such as iron or magnets, to boost the magnetic field of the structure. Non-conductive element 22 may contain magnetic particles that respond to the magnetic field created by the wires. For example, non-conductive element 22 can include magneto-rheological fluid or magneto-rheological elastomer that changes in viscosity or stiffness in the presence of a magnetic field.

In some embodiments, fiber sheath 16 can be layered from a single, continuous conductive fiber 20. In some embodiments, fiber sheath 16 can be made from several conductive fibers 20 that are wound or braided automatically. These methods would require that conductive fibers 20 be electrically connected in the correct pattern after the structure is formed. These electrical connections could be facilitated by end couplers 26. In the case of a PAM, conductive fibers 20 could be connected so that the path of the current always circles the axis A-A of soft fluidic actuator 13 in the same direction.

In some embodiments, conductive fibers 20 can be supported atop non-conductive element 22, such as flexible beam-like element, or in an elastomer. Conductive fibers 20 can include non-conductive elements 22, such as non-conductive, high-tensile strength fibers. The forces that are created by internal or external forces on self-sensing fiber-driven motion system 10 may be manifest as strain in conductive fibers 20. This strain could be measured in changes in resistance of circuit 31 formed by conductive fibers 20. Thus the resistance of circuit 31 could provide a way to measure the internal or external forces on the self-sensing fiber-driven motion system 10. If the forces create strain in conductive fibers 20 then the resistance method of measuring force could be used but this may require that conductive fibers 20 be strong and resilient to withstand repeated stress cycles. Examples of these types of conductive fibers 20 are metal beams, metallic wires or carbon wires. These conductive fibers 20 would need to be connected with appropriate junctions, which could be facilitated by end couplers 26 or by using continuous lengths of conductive fibers 20. Conductive fibers 20 may be partially or completely isolated from the internal and external forces on the self-sensing fiber-driven motion system 10 by placing conductive fibers 20 inside non-conductive elements 22, such as reinforcing beams. Conductive fibers 20 may be embedded in non-conductive elements 22, such as an elastomer or flexible structure. Conductive fibers 20 could be made from conductive inks, additives or low-melting-point alloys atop other elements. Conductive fibers 20 could deform in a way different than non-conductive elements 22 allowing the inductance of circuit 31 formed by conductive fibers 20 to be sensitive to deformations that occur outside the direction of actuation of self-sensing fiber-driven motion system 10.

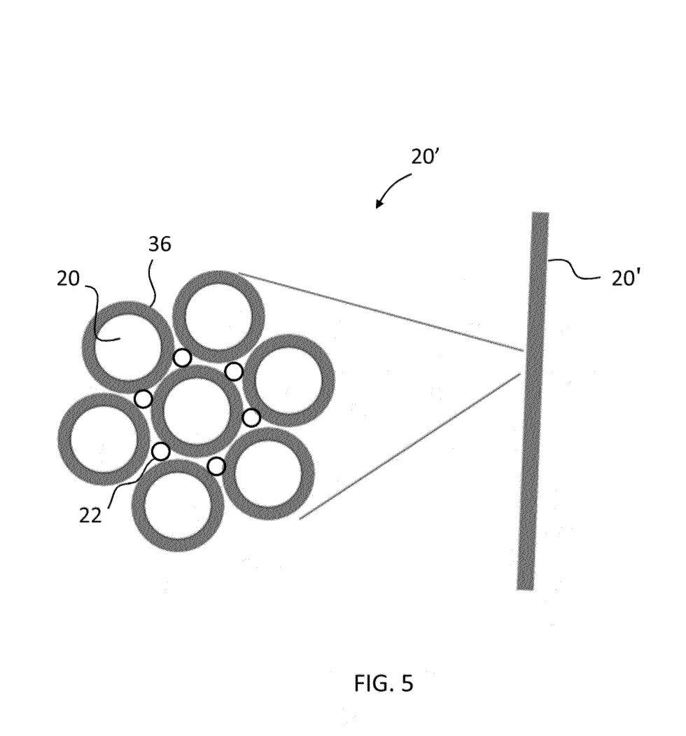

With reference to FIG. 5, in some embodiments, a plurality of conductive fibers 20, each having an electrically insulating material 36, can be used in a bundle 20′. Each conductive fiber 20 could be a single conductive wire or multiple wires running alongside each other. The current in each conductive fiber 20 can run in the same direction thereby forming bundle 20′ that can serve in the place of a single conductive fiber 20. The effect of bundle 20′ is to increase the inductance of the circuit 31 formed by conductive fibers 20. When each of the plurality of conductive fibers 20 is wired in series, the overall inductance of circuit 31 can be increased. Bundle 20′ could be made with bundles of mutually insulated conductive fibers 20 similar to “Litz” wires. Unlike Litz wires, however, the ends of the individual conductive fibers 20 would not be connected in parallel. Rather, conductive fibers 20 would be connected in series with the rest of circuit 31. This technique could be used to boost the inductance of circuit 31. One way to understand why this leads to an increase in inductance is to inspect the long solenoid equation set forth herein as Equation (6). Adding mutually insulated conductive fibers 20 that run alongside one another with the current flowing in the same direction is analogous to boosting the number of turns N.

It should be understood, however, that conductive fibers 20 can comprise any one of a number of material combinations. In some embodiments, conductive fibers 20 can be used in conjunction with non-conductive elements 22. In this way, the combination of conductive fibers 20 and non-conductive elements 22 can collectively define fiber sheath 16. Generally, fiber sheath 16 is substantially inextensible.

Soft Fluidic Actuators

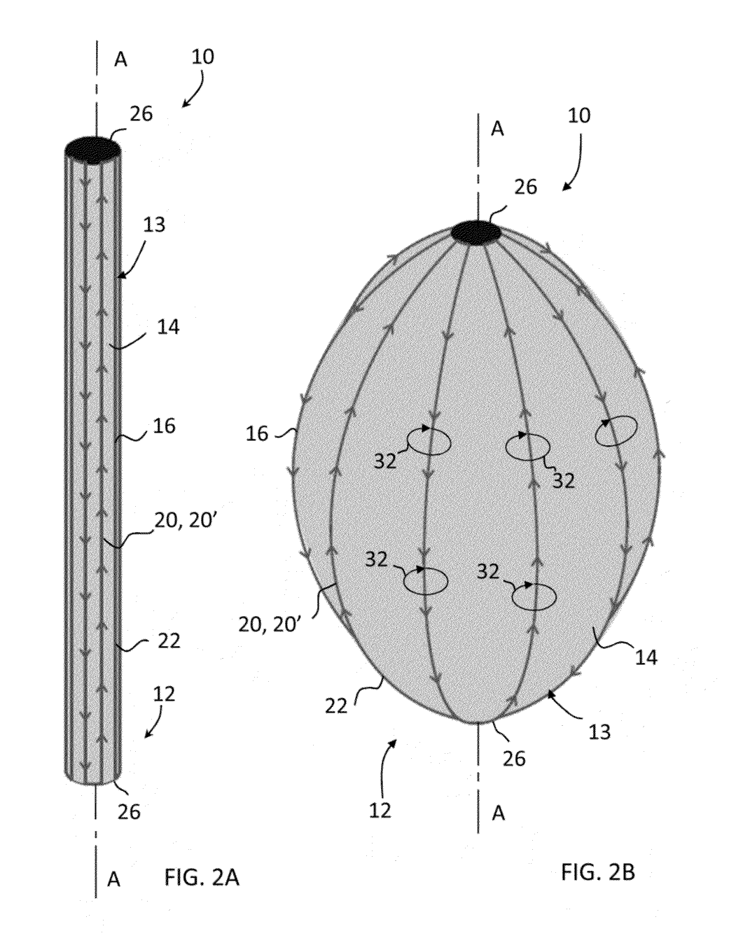

With reference to FIGS. 1A, 1B, 2A, 2B, 3A, 3B, 6A and 6B, fiber sheath 16 can comprise one or more conductive fibers 20 disposed about flexible bladder 14. In some embodiments, as specifically illustrated in FIGS. 1A and 1B, conductive fibers 20 can be disposed in any one of a number of orientations or patterns, such as, but not limited to, an alternating helical pattern. As will be discussed in greater detail, in some embodiments as illustrated in FIGS. 2A and 2B, conductive fibers 20 can be disposed in a parallel pattern generally aligned along a longitudinal direction, such as generally parallel to longitudinal axis A-A.

During operation, the inner volume of flexible bladder 14 is pressurized by the introduction of pressurized air or other liquid. Pressurization of flexible bladder 14 results in inflation of flexible bladder 14 acting against fiber sheath 16. When soft fluidic actuator 13 is a PAM, flexible bladder 14 increases in volume (radially) thereby resulting in contraction along a direction aligned with longitudinal axis A-A (axially). Generally, fiber sheath 16 is substantially inextensible; therefore, the volume increase of flexible bladder 14 of a PAM soft fluidic actuator 13 results in the radial expansion of fiber sheath 16. During this expansion, conductive fibers 20 of fiber sheath 16 may become more perpendicularly oriented relative to axis A-A. That is, a measured angle between axis A-A and conductive fiber 20, denoted as α (FIG. 1A), may increase to a greater angle between axis A-A and conductive fiber 20 following expansion of flexible bladder 14, denoted as β (FIG. 1B).

In some embodiments, sensing system 12 of self-sensing fiber-driven motion system 10 can comprise one or more end couplers 26. End couplers 26 can each be optionally used to electrically and/or mechanically join individual conductive fibers 20 and, in some embodiments, mechanically join non-conductive elements 22. For example, in some embodiments, end coupler 26 can be used to electrically and/or mechanically join one hand of a helix 15 of conductive fiber 20 to an adjacent, opposite hand helix 15′ until a single electrical circuit is formed. When connected to a voltage source 28 via one or more lines 30, current travels up the “muscle” along one helix 15 of conductive fiber 20 and down on another helix of the opposite hand 15′ conductive fiber 20 resulting in a current flow about soft fluidic actuator 13, thereby creating a magnetic field 32 analogous to those of a solenoid. The current in one conductive fiber 20 may run in an opposite direction to the current in an adjacent conductive fiber 20. As can be seen in FIGS. 1A, 1B, 2A, and 2B, end couplers 26 can be used to mechanically constraining ends of soft fluidic actuator 13, thereby resulting in predictable motion of soft fluidic actuator 13 when flexible bladder 14 is pressurized. The end couplers 26 may also serve as a connection point to external elements to transmit mechanical forces and motion.

It should be understood that there exists many variations of the components and operational methods associated with the principles of the present teachings. By way of non-limiting example, in some embodiments, a plurality of soft fluidic actuators 13 and/or fiber-driven motion systems 10 could be coupled in series to magnify the length. In the case of soft fluidic actuators 13, this could also be used to limit the size of the diameter of soft fluidic actuator 13.

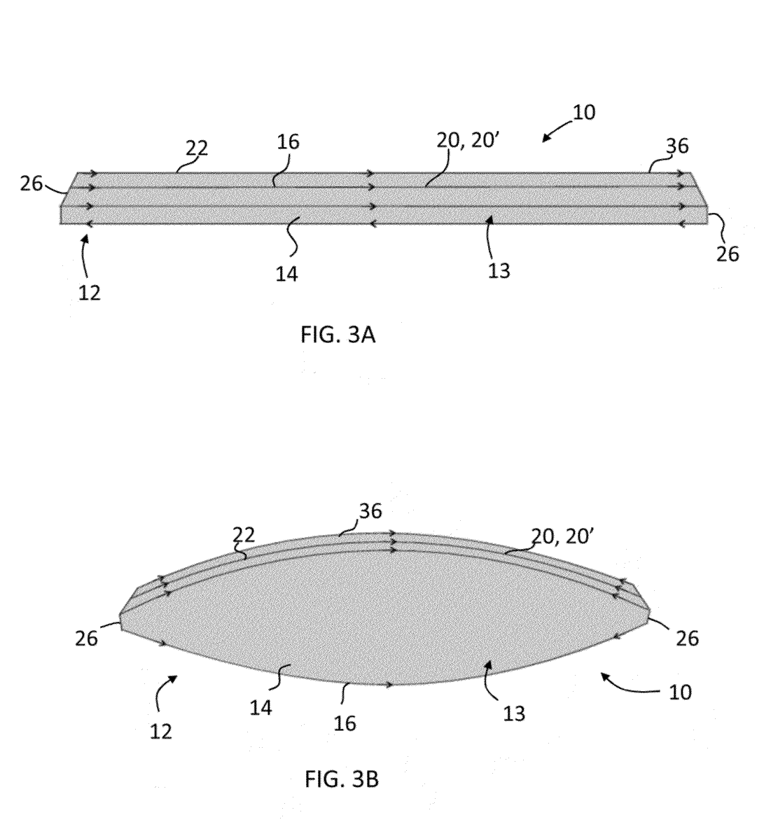

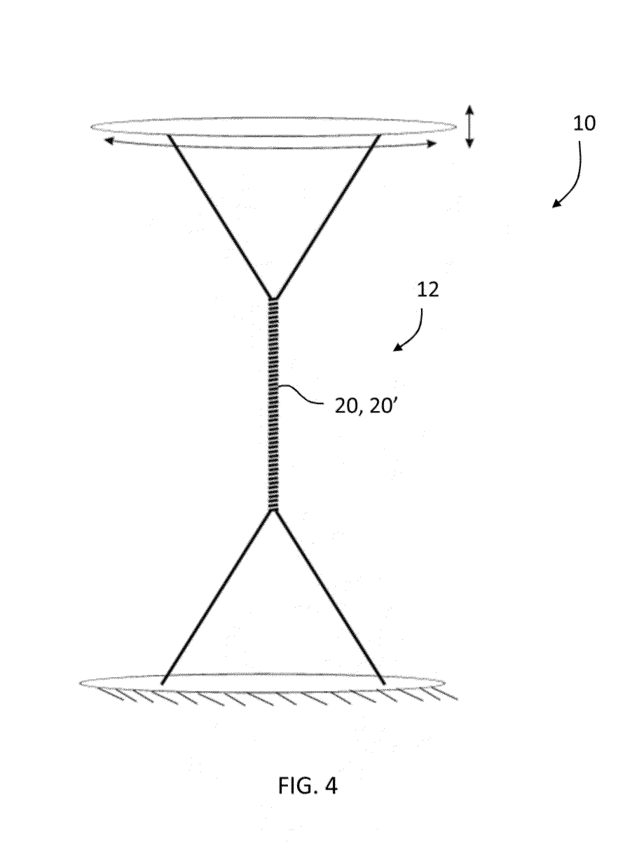

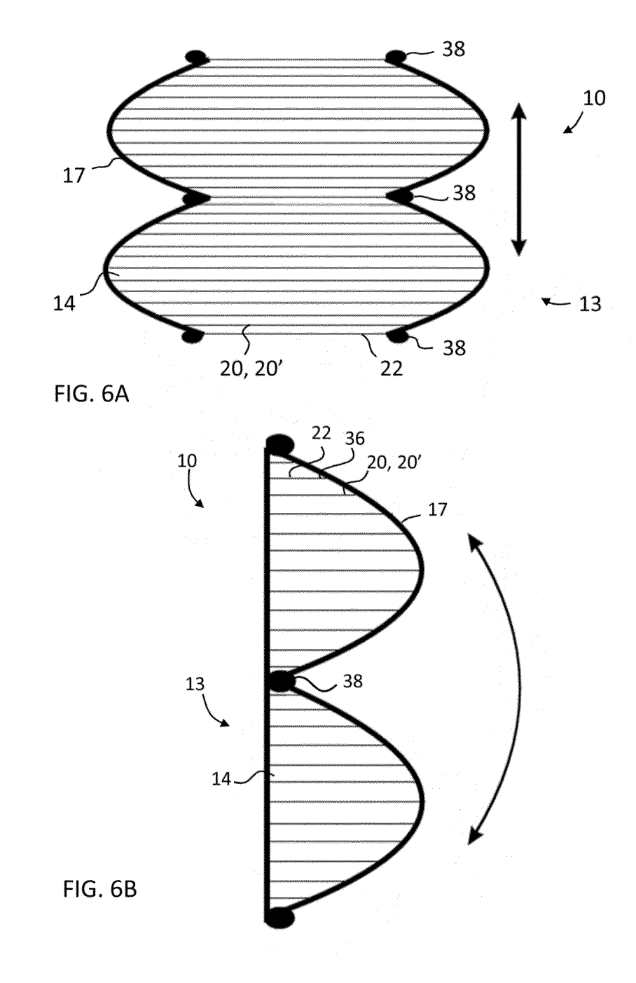

As illustrated in the figures, soft fluidic actuator 13 can comprise any number of shapes, including cylindrical (FIGS. 1A and 1B), bulbous (FIGS. 2A and 2B), rectangular (FIGS. 3A and 3B), or any other shape desired for a particular application. Additionally, fiber sheath 16 can have any one of a number of orientations and/or patterns, including helical (FIGS. 1A and 1B), parallel (FIGS. 2A and 2B, and 6A and 6B), top fibers conducting current in one direction with bottom fiber conducting current in an opposite direction (FIGS. 3A and 3B), coiled (FIG. 4), bundled (FIG. 5), and the like.

Pam Actuators

A simple kinematic model of PAM soft fluidic actuators 13 uses trigonometric relationships for fiber sheath 16. This model has been presented by Chou and Hannaford. This model approximates the structure of fiber sheath 16 as a long cylinder and neglects the effects of the tapering that occurs at the ends of PAM soft-fluidic actuator 13 in contracted conditions. This model also assumes that conductive fibers 20 in fiber sheath 16 are inextensible. The length, l, and diameter, D, of fiber sheath 16 can be written in terms of the fiber angle, θ, with respect to longitudinal axis A-A of soft fluidic actuator 13, the length, b, of the helices of fiber sheath 16 made from conductive fibers 20 and the number of turns, n, that each helix makes around longitudinal axis A-A:

$$\begin{matrix}l = b cos θ & ( 1 ) \\ D = \frac{b sin θ}{n π} & ( 2 )\end{matrix}$$

For PAMs, the helix length b and the number of turns n of each helix remain substantially constant throughout the contraction of soft fluidic actuator 13. Their values can be defined by the length lₑ, diameter dₑ, and winding angle θₑ of the fully-extended PAM soft fluidic actuator 13. The helix length is given by:

$$b = \frac{{l}_{e}}{cos ( {θ}_{e} )} \qquad ( 3 )$$

and the number of turns of each helix by:

$$n = \frac{b sin ( {θ}_{e} )}{{D}_{e} π} \qquad ( 4 )$$

The angle of conductive fibers 20 at any level of contraction, θ, can thus be written in terms of the ratio between the current length of soft fluidic actuator 13, l, and its fully-extended length lₑ:

$$θ = {cos}^{- 1} ( \frac{l}{{l}_{e}} cos ( {θ}_{e} ) ) \qquad ( 5 )$$

These equations provide a simple way to use substantially the constant length of conductive fibers 20 to predict the length, cross-sectional area of soft fluidic actuator and the orientation of conductive fibers 20 in fiber sheath 16 throughout the contraction of soft-fluidic actuator 13.

Straight-Fiber Actuators

Another example of a fiber-driven motion system 10 that is a natural extension of the elements in this work are soft fluidic actuators 13 with fiber sheaths 16 whose elements run parallel to the longitudinal axis A-A (FIGS. 2A-2B and 3A-3B). These straight-fiber soft fluidic actuators 13 may be similar to those proposed in WO 2008140032 A1. These soft fluidic actuators 13 may contract or extend along the axis A-A when their flexible bladder 14 is pressurized. Conductive fibers 20 may be arranged radially with respect to axis A-A among or atop flexible bladder 14. When the volume of flexible bladder 14 expands, soft fluidic actuator 13 grows radially. The substantially constant length of conductive fibers 20 allows fiber sheath 16 to cause the ends of soft fluidic actuator 13 to be drawn together with a force proportional to the driving pressure. Conductive fibers 20 may also experience the stress of the actuation force. Several conductive fibers could be connected in a circuit 31 or circuit 31 could be formed with continuous lengths of conductive fibers 20. Circuit 31 could be formed so that the current moves in opposite directions in adjacent pairs of conductive fibers 20 or conductive fiber bundles 20′. In this way, the magnetic fields 32 of adjacent conductive fibers 20 (or adjacent fiber bundles 20′) would cancel each other less as the distance between conductive fibers 20 (or bundles 20′) increases with the contraction of soft fluidic actuator 13. The manufacturing of this variety of self-sensing soft-fluidic actuator could much easier than those with helical fiber structures.

With reference to FIG. 3, the straight-fiber soft fluidic actuators 13 can be made flat with the fiber sheath running in two layers over the sides of flexible bladder 14 with a rectangular cross-section (when extended) rather than radially distributed around a cylindrical flexible bladder 14. In this configuration, it would be best to have the current in conductive fibers 20 of one layer, flow in the opposite direction of the current in conductive fibers 20 of the other layer.

Bellows-Like Actuators

With reference to FIGS. 6A and 6B, in some embodiments soft fluidic actuators 13 can define a constant surface area. That is, in some embodiments, soft fluidic actuators 13 can define a generally constant surface area during actuation. In this way, the shape of soft fluidic actuator 13 can be periodically constrained using one or more shape-constraining elements 38 to result in a convoluted structure. Conductive fibers 20 can be arranged in parallel to shape-constraining elements 38 resulting in changes in inductance over the course of actuation. With particular reference to FIG. 6A, soft fluidic actuator 13 can extend along its longitudinal axis A-A to define a bellows shape. Alternatively, with reference to FIG. 6B, soft fluidic actuator 13 can that bends with the expansion of the inner volume of flexible bladder 14.

In some soft fluidic actuators 13, fiber sheath 16 may not directly constrain the motion of soft fluidic actuator 13, rather, a flexible membrane 17 such as fabric may be used that does not greatly change in surface area over the course of the actuation. An example of this kind of soft fluidic actuator 13 is a bellows. Bellows may be made with flexible membrane 17 made from, for example, a plastic or elastomeric sheet, elastomer-impregnated fabric, or fabric surrounding a hermetically-sealed flexible bladder 14. For example, a fabric or high-strength sheet of material may be formed over or create flexible bladder 14. Soft fluidic actuator 13 may be made round (See FIG. 6A) or with a flat side (See FIG. 6B). They are often convoluted in their shape. Similar to the straight fiber soft-fluidic actuators 13, the diameter will often be periodically constrained by shape-constraining elements 38 (See FIG. 6A, 38). This leads to the convoluted shape. In the case of a non-cylindrical actuator, the shape may be constrained by non-cylindrical shape-constraining elements 38 (See FIG. 6B, 38). Conductive fibers 20 may be added to these soft-fluidic actuators 13 to sense their motion as well. To get the largest change in inductance, conductive fibers 20 (or bundles 20′) (FIG. 6, 20) may run parallel to shape-constraining elements 38 (FIG. 6, 38). For ease of manufacturing, conductive fibers 20 may be placed exclusively at the location of shape-constraining elements 38. Conductive fibers 20 may be wired in series and the self-inductance of circuit 31 may be measured or conductive fibers 20 could be wired to different circuits 31 and the mutual inductance of the circuits 31 could be measured to quantify the motion of soft fluidic actuator 13.

Fiber-Driven Elastomeric Enclosure Actuators

According to the principles of the present teachings, fiber-driven motion system 10 can be configured as a self-sensing Fiber-driven Elastomeric Enclosures (FREE). These FREE soft fluidic actuators 13 may be similar to those proposed in US 20150040753 A1. Fiber sheath 16 used in these actuators could be replaced or augmented by conductive fibers 20 that sense the degree of motion in the actuator by observing changes in inductance of circuit 31 formed from conductive fibers. Changes in the inductance of circuit 31 may come from changes in the angle of conductive fibers with respect to the longitudinal axis A-A (pitch) or other changes in the shape of fiber sheath 16. FREEs are very similar to PAMs. The difference is that the pitch of the helical fibers in fiber sheath 16 may take different values in the initial configuration. Whereas, in the case of PAMs, the pitch of the right-handed helices 15 and left-handed helices 15′ is the same, with FREEs the helices 15 may be of the same or different hand with the same or different pitch. These actuators can be combined with additional fibers or other high-stiffness elements to further shape the actuation.

Coiled Fiber Actuators

With particular reference to FIG. 4, coiled-fiber actuator 18 is illustrated wherein conductive fibers 20 are coiled into tightly-wound coil 40. Changes in the pitch or number of turns in tightly-wound coil 40 results in a change in inductance of circuit 31 formed with conductive fibers 20. The inductance of circuit 31 can be associated and/or representative of motion along the longitudinal axis A-A of coiled-fiber actuator 18.

Coiled-fiber actuators 18 are an example of a fiber-driven motion system 10 that, by natural extension of the elements in this work, could be made into self-sensing fiber-driven motion system 10. Coiled-fiber actuators may be similar to those proposed in US 20080066574 A1 or WO 2014022667 A3). These systems are driven by tightly-wound coil 40 of fibers. The changing pitch or number of turns in tightly-wound coil 40 s is used to drive coiled-fiber actuator 18. The changes in tightly-wound coil 40 may also be driven by an external torque or by a force parallel to longitudinal axis A-A. In some cases, coiled-fiber actuators 18 have the rotation of tightly-wound coil 40 coupled to a member rotating about longitudinal axis A-A such as an electric motor or a robot joint. In some cases, coiled-fiber actuators 18 use the change in length of tightly-wound coil 40 to drive translational motion along the longitudinal axis A-A.

Similar to our preferred embodiment, the fibers of tightly-wound coil 40 of coiled-fiber actuators 18 could be replaced or augmented by conductive fibers 20 that form circuit 31. The changes in pitch or number of turns of tightly-wound coil 40 could be detected by changes in inductance in circuit 31. Conductive fibers 20 would need to be electrically insulated from one another. Conductive fibers 20 that make up circuit 31 could be wired so that the current flows up one fiber in tightly-wound coil 40 and down another other. In this configuration, the more coiled the fibers, the more the fields of the two conductive fibers 20 would cancel. It would be easy to boost the overall inductance of the circuit 31 in this method employing bundles 20′ of mutually insulated conductive fibers 20 whose currents run parallel to one another. Another possible configuration would be to allow the current to run along fibers of tightly-wound coil 40 in the same direction. In this configuration, the inductance of circuit 31 would increase as tightly-wound coil 40 is wound more tightly. In this configuration, it would be more difficult to boost the overall inductance value of circuit 31 because using bundles 20′ of conductive fibers 20 wired in series may be difficult. For conductive fibers 20 in bundle 20′ to be wired in series with the current flowing in the same direction, a return path must be provided in circuit 31 for each conductive fiber 20 in bundle 20′.

In some cases, the coiled-fiber actuator 18 is actuated by strain in the tightly-wound coil created from thermal stresses. These thermal stresses may be created in conductive fibers 20 made from nylon fibers coated with silver or carbon. Conductive fibers 20 may be yarn-like structures made from carbon nanotubes. The thermal expansion may come from a wax-like material among conductive fibers 20.

Externally Actuated Configurations

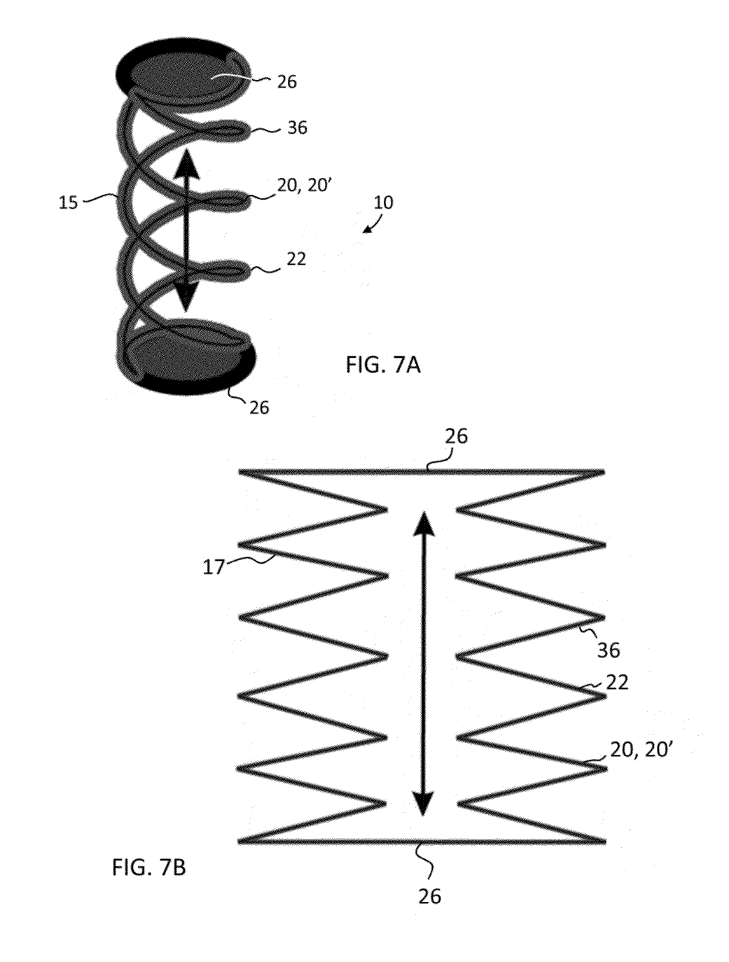

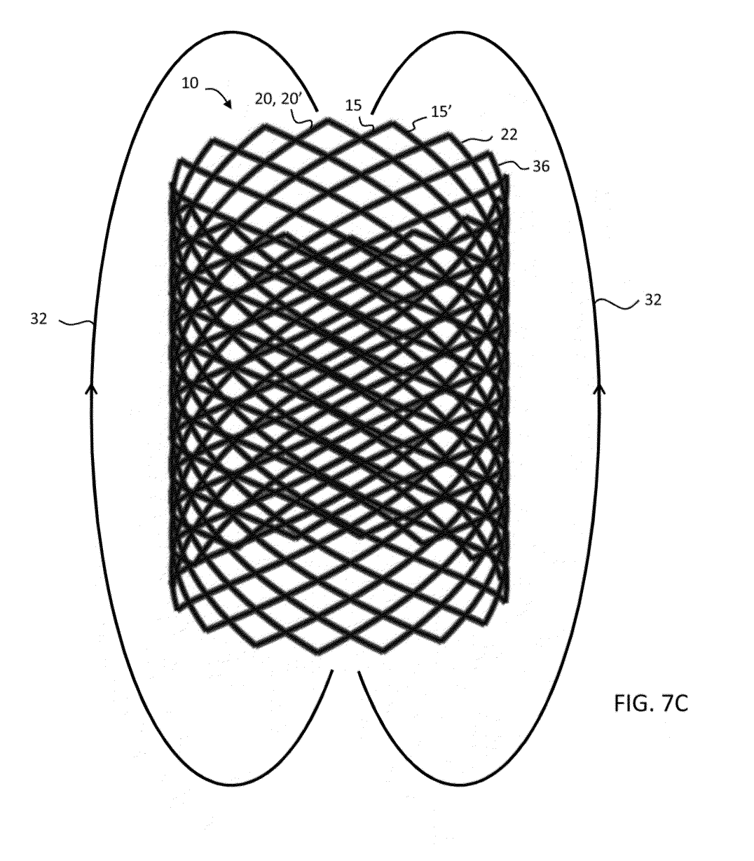

In some embodiments, as illustrated in FIGS. 7A-7C, the self-sensing fiber-driven motion system 10 may not include an actuator but may be actuated by external forces. In this case, the shape of the self-sensing fiber-driven motion system 10 responds passively to external forces according to the strain in non-conductive elements 22 that run alongside conductive fibers 20. An example of such a system without self-sensing fibers would be a traditional helical spring. A spring stretches or compresses when subjected to an external force parallel to the axis of the helices of the spring. Using conductive fibers 20 along with flexible non-conductive elements 22 that are spring-like (e.g. a structure that passively creates a force when compressed) can result in a self-sensing fiber-driven motion system 10 that can sense its deflection from equilibrium.

Conductive fibers 20 could be wired in series into a circuit 31 whose inductance changes with the motion of this self-sensing fiber-driven motion system 10. This self-sensing fiber-driven motion system 10 could provide distance measurements in wet and dirty environments where traditional, sliding-surface sensors are unfit. They could also, for example, be placed alongside the human body to measure joint motion.

As has been clarified before, the “non-conductive” elements 22 may be non-conductive in the sense they do not conduct the current of circuit 31 though they may be made of conductive materials (such as steel or other metals). Similarly, conductive fibers 20 (such as metal beams) could be used with or without non-conducting elements 22 to form these structures. Electrically insulated conductive fibers 20 would be desirable, however, to ensure that the current in circuit 31 only flowed along the length of conductive fibers 20.

It is also possible to use bundles 20′ of conductive fibers 20 in these structures. It may be desirable to make the non-conductive elements 22 very flexible to limit the amount of force required to create a deflection in the self-sensing fiber-driven motion system 10. Measuring the electrical properties of circuit 31 formed with conductive fibers 20 (e.g. self-inductance, resistance, and/or capacitance) could be used to determine motion state of the flexible structure.

Conductive fibers 20 may be bundles 20′ of conductive fibers 20 in this self-sensing fiber-driven motion system 10. Conductive fibers 20 can be arranged in a variety of configurations. The inductance of the resulting circuit 31 will change as the non-conductive elements 22 forming the flexible structure that conductive fibers 20 embedded in changes shape.

For example, as illustrated in FIG. 7A a conductive fibers 20 are guided by non-conductive elements 22 into a path of two helices of the same hand 15. Conductive fibers 20 follow the contours of non-conductive elements 22 in the form of a two-start helical spring. As the spring contracts, conductive fibers 20 will cancel each other's magnetic fields 32 to a greater degree and the inductance of the circuit 31 will be lower.

In FIG. 7B, a planar device is depicted for measuring extension. As the device extends, magnetic fields 32 of conductive fibers 20 will cancel each other to a lesser degree, resulting in an increase in inductance.

In FIG. 7C, conductive fibers 20 ascend upwards along one hand of helix 15 and downwards along another hand of helix 15′, similar to fiber sheath 16 of a PAM soft fluidic actuator 13.

Inductance Modeling

For a PAM or FREE soft fluidic actuator 13, the simplest way to model the change in inductance of circuit 31 is to approximate circuit 31 as a long solenoid. The long solenoid approximation provides an easy-to-compute, closed-form equation for inductance. Its applicability is unique to the solenoid-like structure of fiber sheath 16. The inductance of circuit 31 is approximated by

$$L = μ \frac{{N}^{2} A}{l} \qquad ( 6 )$$

where μ is the magnetic permeability of the core and N is the number of turns. A and l are the cross-sectional area and the length of fiber sheath 16, respectively. When PAM soft fluidic actuator 13 is pressurized, its volume increases. Fiber sheath 16 cause the length of soft fluidic actuator 13 to decrease as its cross-sectional area expands. The shortening and widening of soft fluidic actuator 13 lead to an increase in inductance of circuit 31. In the case of a PAM soft fluidic actuator 13, the number of turns remains constant throughout the stroke. This makes the inductance of circuit 31 very sensitive to motion of soft fluidic actuator 13.

The long solenoid approximation assumes that the length of fiber sheath 16 is much larger than the cross-sectional area. Furthermore, it assumes that the current always circles the axis A-A perpendicularly in the same direction and that the profile of fiber sheath 16 is cylindrical. By combining the long solenoid equation (6) with the equations for fiber sheath 16, one can predict how the inductance of circuit 31 will change with actuator contraction. To approximate the inductance circuit 31 at a given fiber angle, θ, (6) can be evaluated in terms of the cross-sectional area, A, given (2) and the length of the actuator given by (1). The number of turns made by the complete circuit, N, is equal to the product of the number turns made by each helix, n, and the number of helices that make up the braid. Over a typical range of fiber angles for contractile PAM soft fiber actuators 13, we would expect the inductance of circuit 31 change approximately linearly with respect to the length of soft fiber actuator 13.

The Neumann formula provides a way to predict changes in inductance for a broader class of deforming circuits 31. This method relies on the integration of the mutual inductance equation formulated by Franz Ernst Neumann. This expression does not rely on the assumptions of the long solenoid equation. Instead, it provides an expression for the mutual inductance of two, infinitesimally thin conductive fibers 20 in terms of curve integrals. This equation has been reformulated by R. Dengler to provide an expression for the self-inductance of a single loop of wire of arbitrary geometry.

In this formulation, circuit 31 is defined by a curve, C, with differential elements \vec{ds}. The self-inductance is expressed by a double curve integral over C:

$$L = {( \frac{{μ}_{0}}{4 π} {∮}_{C} {∮}_{{C}^{′}} \frac{\vec{d s} \cdot \vec{d {s}^{′}}}{‖ \vec{{R}_{{ss}^{′}}} ‖} )}_{‖ \vec{{R}_{{ss}^{′}}} ‖ > 2 a} + \frac{{μ}_{0}}{4 π} \vert C \vert Y \qquad ( 7 )$$

The inductance is high when many pairs of differential elements (\vec{ds} and \vec{ds′}) are aligned and have a small distance ∥\vec{R_{ss′}}∥ between them.

The inductance calculated by this method is not exact but provides a good approximation for circuits 31 without many sharp corners and with where the total length of conductive fibers 20 in the circuit 31, |C|, is much greater than the radius of conductive fibers 20, a. Y is a correction factor that depends on the current distribution in conductive fiber 20. At very high frequencies of current, the skin effect will cause the current to become concentrated in the surface of conductive fibers 20 (Y=0), at lower frequencies, the current will be more evenly distributed in conductive fibers 20 (Y=0.5).

In the case of straight-fiber soft fluidic actuators 13, from the Neumann Formula (7) it is apparent that current segments of opposite direction have a negative contribution to the total inductance (from the inner product of the differential elements). The size of this contribution is inversely proportional to the distance between the opposite currents. That is, as conductive fibers 20 move further apart, the canceling effect is reduced and the remaining inductance approaches the self-inductance of long conductive fibers 20 (or of the self-inductance of the bundles 20′ of conductive fibers 20).

Force Sensing with Resistance

The stress from internal and external forces on fiber sheath 16 or tightly wound coil 40 may result in strain in conductive fibers 20 that can be measured through changes in the resistance of the circuit 31.

The change in resistance comes from a mechanism very similar to that of a strain gauge. If we assume constant resistivity, the resistance of the wires R should vary linearly with the stain ε:

$$\frac{Δ R}{R} = ( 1 + 2 v ) ɛ \qquad ( 8 )$$

where v is Poisson's ratio. This equation can be rewritten with the initial resistance R₀, the stress in the fibers σ, and the elastic modulus E:

$$R = \frac{( 1 + 2 v ) {R}_{0}}{E} σ + {R}_{0} \qquad ( 9 )$$

Davis showed that the tensile stress in fiber sheath 16 of a PAM soft fluidic actuator 13 is a linear function of the gauge pressure in flexible bladder 14. The relationship between the actuation force of PAM soft fluidic actuator 13 is also linear with respect to pressure. The intensity of the stress in fiber sheath 16 and the intensity of the actuation force depends on the contraction state of soft fluidic actuator 13.

The force sensitivity of the system can be boosted by using very small diameter conductive fibers 20. Decreasing the cross-sectional area of conductive fibers 20 results in a higher stress per conductive fibers 20 and a higher resistance. Measuring small inductances with relatively large resistances can be difficult. Each of these effects can be mitigated by creating bundles 20′ out of the thin diameter conductive fibers 20 to increase the inductance and redistribute the stress.

Sensing System

The circuit 31 forms part of an electronic sensing system that uses the electrical properties of circuit 31 to determine quantitative shape deformation of circuit 31. This is primarily accomplished through the inductance of circuit 31. The resistance of circuit 31 may also be used to determine the strain in conductive fibers 20 that make up circuit 31.

Lines 30 of circuit 31 may be connected to voltage source 28 that excites circuit 31 with the end of determining the electrical properties. Voltage source 28 may be a current source. Voltage source 28 may be oscillating in a sinusoidal fashion at one or several frequencies. The reactance of the structure to the current from the voltage source 28 could be used to determine the inductance and capacitance. In addition to measuring the inductance of circuit 31, capacitance could also be measured. Indeed, the alternating current (AC) impedance at a range of frequencies could be used. All circuits 31 have parasitic capacitance and changes in this capacitance could yield additional insight into the shape of circuit 31.

Lines 30 may be connected in series or parallel with a capacitor to form a tank circuit out of circuit 31. The frequency of the oscillation of circuit 31 determined by the inductance and capacitance. The power required to sustain this oscillation would reveal the equivalent parallel resistance of the tank circuit. This could be used to detect whether the inductance is being skewed by proximity to conductive or ferromagnetic materials. If a lot of eddy current is being induced in a nearby structure, then the equivalent parallel resistance will be lower.

Conductive fibers 20 may be connected into different circuits 31′. Individual circuits 31 need not be connected to one another. In this way, there is some redundancy in the system. If one circuit 31, becomes ruptured, other different 31′ circuits could be used. Different circuits 31′ could be used to reveal different aspects of the shape of the structure they are affixed to.

The electrical properties of circuit 31 may be used in feedback control of a robotic or automated device. They may provide information to a computer or they may provide information to a human user.

Surrounding circuit 31 with a relatively thin, conductive structure could prevent the propagation and reception of electromagnetic interference. This conductive structure could serve as a Faraday cage.

Discussion of Performance

We tested a PAM soft fluidic actuator 13 with sensing system 12 described in this work. The inductance of circuit 31 able was able to determine the contraction to within about a millimeter with only a linear calibration of the inductance measurements.

With heavy loads, sensor system 12 precision differs slightly from measurements taken at the joint that soft fluidic actuator 13 is connected to. We believe this is caused by compliance in the connections to soft fluidic actuator 13. This is a weakness of any sensing system 12 that measures the length of a fiber-driven motion system 10. Fortunately, there are several possible ways to resolve this. The first is to make the connections as stiff as possible. Another way is to use redundant sensor measurements. PAM soft fluidic actuators 13 are commonly used in antagonized configurations. An antagonized pair of self-sensing fiber-driven motion systems 10 would provide a degree of sensor redundancy to help correct for these small errors. Finally, one could compensate for these errors by measuring the magnitude of the end-load and modeling the elasticity of the connections. In the case of a soft fluidic actuator, the end-load can be estimated from the pressure inside flexible bladder 14. This can be measured, for example via a pressure sensor. Alternatively, the resistance-strain relationship of conductive fibers 20 in circuit 31 can measure the force output directly.

Performance of Other Methods

The inductance of a circuit 31 is not the only proposed sensing system 31 for soft fluidic actuators 13. Rather than have a fiber sheath 16 with conductive fibers 20, other sensing systems 12 have relied on modifications to flexible bladder 14. Goulbourne and Son tested cylindrical dielectric elastomers in extension and found a linear sensor response. They postulated that these sensors could be useful as flexible bladders 14 in soft fluidic actuators 13. The dielectric elastomer in these experiments was constructed using carbon grease to create electrodes on the surfaces of an elastomer. Elastomers such as these have the intriguing possibility of serving as both a sensor and an actuator. A different technique, demonstrated by Park and Wood added an elastomeric sheath to soft fluidic actuator 13. The elastomeric sheath was formed with a micro-channel which was injected full of a low melting point alloy (Eutectic Gallium Indium). The strain in the elastomeric sheath caused strain in the micro-channel which resulted in a change of resistance. They identified a linear response in the resistance of the conductor. It is possible that methods in accordance with the principles of the present teachings wherein sensing system 12 relies on changes in the electrical properties of circuit 31 forming part of fiber sheath 16 could show greater resilience under repeated strain.

Advantages

The present teachings provide a number of advantages. Sensing system 12 can provide information about the force output and position of fiber-driven motion systems 10. This makes them self-sensing fiber-driven motion systems 10 that can be used as servo actuators. The materials required for these sensors are very low cost (e.g. insulated wire) and can, in many cases, be implemented without the addition of mechanical components to the fiber-driven motion systems 10. That is, the existing fibers can be used. This results in a reduction of system complexity. Because sensing system 12 does not rely on precisely aligned mechanical joints; it can be used with compliant joints, human joints or continuum robots. The resulting self-sensing fiber-driven motion systems 10 can be used with joints with multiple degrees of freedom. Because the force output of the self-sensing fiber-driven motion systems 10 can also be characterized through the resistance of circuit 31, feedback control of force output is also enabled without adding external sensors or relying on models of force generation or response. The ability of this sensing system 12 to work with flexible and compliant joints allows it to be used with systems that are built with looser tolerances or flexible materials. This allows the overall system cost to be reduced. And finally, sensing system 12 proposed in this work, is robust to operation in dirty environments; environments where dust, salinity, oil, particulates, water or other contaminates would impede the function of other sensing systems 12.

Accordingly, the present teachings provide various embodiments that overcome the disadvantages of the prior art. By way of example, in some embodiments, a self-sensing fiber-driven motion system is provided comprising an actuator being moveable between a first configuration and a second configuration; a plurality of fibers generally surrounding the actuator, the plurality of fibers changing from a first orientation to a second orientation in response to force exerted upon the plurality of fibers in response to movement of the actuator from the first configuration to the second configuration; a plurality of electrically conductive elements generally following at least one of the plurality of fibers, an electrical condition of the plurality of electrically conductive elements changing from a first electrical condition to a second electrical condition in response to the changing of the plurality of fibers from the first orientation to the second orientation; and a sensor system detecting a change of electrical condition from the first electrical condition to the second electrical condition, the sensor system determining a movement of the actuator in response to the change of electrical condition.

In some embodiments of the self-sensing fiber-driven motion system, the electrical condition is resistance.

In some embodiments of the self-sensing fiber-driven motion system, the electrical condition is capacitance.

In some embodiments of the self-sensing fiber-driven motion system, the electrical condition is inductance.

In some embodiments of the self-sensing fiber-driven motion system, the actuator is a flexible bladder having an inner volume, the inner volume being expandable from the first configuration to the second configuration in response to application of fluid pressure within the inner bladder, wherein the plurality of fibers generally surrounds the flexible bladder and constrains the expansion of the inner bladder from the first configuration to the second configuration to create a desired motion, and wherein the sensor system detecting a change in the inductance to determine a degree of actuation of the flexible bladder.

In some embodiments of the self-sensing fiber-driven motion system, at least one of the plurality of electrically conductive elements is integrally formed with the plurality of fibers.

In some embodiments of the self-sensing fiber-driven motion system, the plurality of electrically conductive elements and the plurality of fibers are collectively embodied in a single unitary member.

In some embodiments of the self-sensing fiber-driven motion system, the single unitary member is insulated metal wire.

In some embodiments of the self-sensing fiber-driven motion system, at least one of the plurality of electrically conductive elements bears the force exerted upon the plurality of fibers thereby resulting in application of strain upon the at least one electrically conductive elements resulting in the change from the first electrical condition to the second electrical condition.

In some embodiments of the self-sensing fiber-driven motion system, the plurality of fibers are disposed in a helical pattern about the actuator.

In some embodiments of the self-sensing fiber-driven motion system, the plurality of fibers are disposed in a helical pattern about the actuator that results in a change in pitch of the plurality of fibers when moving between the first configuration and the second configuration.

In some embodiments of the self-sensing fiber-driven motion system, the plurality of fibers are disposed about the actuator in a periodic orientation to define a convoluted structure.

In some embodiments of the self-sensing fiber-driven motion system, the plurality of fibers are disposed in a helical pattern about the actuator, the helical pattern defining varying pitch along the actuator.

In some embodiments of the self-sensing fiber-driven motion system, the plurality of fibers are disposed in a parallel pattern along the actuator when the actuator is in the first configuration.

In some embodiments of the self-sensing fiber-driven motion system, the plurality of fibers are no longer in the parallel pattern when the actuator is in the second configuration.

In some embodiments of the self-sensing fiber-driven motion system, each of the plurality of electrically conductive elements is electrically insulated from adjacent electrically conductive elements.

In some embodiments of the self-sensing fiber-driven motion system, a magnetic material is generally positioned to enhance magnetic flux created by the plurality of electrically conductive elements.

In some embodiments of the self-sensing fiber-driven motion system, the plurality of fibers are coiled in a helix pattern such that changes in the shape of the plurality of fibers or in the number of turns in the helix pattern results in a force or motion along the axis of the helix.

In some embodiments of the self-sensing fiber-driven motion system, the plurality of electrically conductive elements is made of a material chosen from the group consisting of liquid metal, conductive paint, conductive ink, conductive tape, and elastomer with embedded conductive materials.

In some embodiments of the self-sensing fiber-driven motion system, the plurality of fibers undergo internal strain in response to a change in temperature.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A self-sensing fiber-driven motion system comprising:
an actuator being moveable between a first configuration and a second configuration;
a plurality of fibers generally surrounding the actuator, the plurality of fibers changing from a first orientation to a second orientation in response to force exerted upon the plurality of fibers in response to movement of the actuator from the first configuration to the second configuration;
a plurality of electrically conductive elements generally following at least one of the plurality of fibers, an electrical condition of the plurality of electrically conductive elements changing from a first electrical condition to a second electrical condition in response to the changing of the plurality of fibers from the first orientation to the second orientation; and
a sensor system detecting a change of electrical condition from the first electrical condition to the second electrical condition, the sensor system determining a movement of the actuator in response to the change of electrical condition.

2. The self-sensing fiber-driven motion system according to claim 1 wherein the electrical condition is resistance.

3. The self-sensing fiber-driven motion system according to claim 1 wherein the electrical condition is capacitance.

4. The self-sensing fiber-driven motion system according to claim 1 wherein the electrical condition is inductance.

5. The self-sensing fiber-driven motion system according to claim 4 wherein the actuator is a flexible bladder having an inner volume, the inner volume being expandable from the first configuration to the second configuration in response to application of fluid pressure within the inner bladder,
wherein the plurality of fibers generally surrounds the flexible bladder and constrains the expansion of the inner bladder from the first configuration to the second configuration to create a desired motion, and
wherein the sensor system detecting a change in the inductance to determine a degree of actuation of the flexible bladder.

6. The self-sensing fiber-driven motion system according to claim 1 wherein at least one of the plurality of electrically conductive elements is integrally formed with the plurality of fibers.

7. The self-sensing fiber-driven motion system according to claim 1 wherein the plurality of electrically conductive elements and the plurality of fibers are collectively embodied in a single unitary member.

8. The self-sensing fiber-driven motion system according to claim 7 wherein the single unitary member is insulated metal wire.

9. The self-sensing fiber-driven motion system according to claim 1 wherein at least one of the plurality of electrically conductive elements bears the force exerted upon the plurality of fibers thereby resulting in application of strain upon the at least one electrically conductive elements resulting in the change from the first electrical condition to the second electrical condition.

10. The self-sensing fiber-driven motion system according to claim 1 wherein the plurality of fibers are disposed in a helical pattern about the actuator.

11. The self-sensing fiber-driven motion system according to claim 1 wherein the plurality of fibers are disposed in a helical pattern about the actuator that results in a change in pitch of the plurality of fibers when moving between the first configuration and the second configuration.

12. The self-sensing fiber-driven motion system according to claim 1 wherein the plurality of fibers are disposed about the actuator in a periodic orientation to define a convoluted structure.

13. The self-sensing fiber-driven motion system according to claim 1 wherein the plurality of fibers are disposed in a helical pattern about the actuator, the helical pattern defining varying pitch along the actuator.

14. The self-sensing fiber-driven motion system according to claim 1 wherein the plurality of fibers are disposed in a parallel pattern along the actuator when the actuator is in the first configuration.

15. The self-sensing fiber-driven motion system according to claim 14 wherein the plurality of fibers are no longer in the parallel pattern when the actuator is in the second configuration.

16. The self-sensing fiber-driven motion system according to claim 1 wherein each of the plurality of electrically conductive elements is electrically insulated from adjacent electrically conductive elements.

17. The self-sensing fiber-driven motion system according to claim 1, further comprising:
magnetic material generally positioned to enhance magnetic flux created by the plurality of electrically conductive elements.

18. The self-sensing fiber-driven motion system according to claim 1 wherein the plurality of fibers are coiled in a helix pattern such that changes in the shape of the plurality of fibers or in the number of turns in the helix pattern results in a force or motion along the axis of the helix.

19. The self-sensing fiber-driven motion system according to claim 1 wherein the plurality of electrically conductive elements is made of a material chosen from the group consisting of liquid metal, conductive paint, conductive ink, conductive tape, and elastomer with embedded conductive materials.

20. The self-sensing fiber-driven motion system according to claim 1 wherein the plurality of fibers undergo internal strain in response to a change in temperature.
